(19) United States
(12) Patent Application Publication
(10) Pub. No.: US 2005/0154098 A1
(43) Pub. Date: Jul. 14, 2005

(54) Fade-resistant fluorescent retroreflective articles

(75) Inventor: Edward D. Phillips, Oakville, CT (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Reflexite Corporation, Avon, CT (US)

(21) Appl. No.: 10/754,897

(22) Filed: Jan. 9, 2004

(51) Int. Cl. C08L 1/00

(52) U.S. Cl. 524/91

(57) ABSTRACT

A fade-resistant fluorescent colorant composition includes a polymer; a fade-susceptible fluorescent colorant, provided the fluorescent colorant is not a perylene imide derivative; and a hindered amine light stabilizer of molecular weight greater than about 1,200 AMU. The hindered amine light stabilizer includes at least one secondary or tertiary hindered amine. A fade-resistant retroreflective article includes the colorant composition and a retroreflective structure, comprising an array of transparent optical elements. Also included are methods for forming the composition and articles.

### BACKGROUND OF THE INVENTION

The advantages of high visibility colored materials, alone and in combination with retroreflective materials, are well known. Such materials are widely employed, for example, in traffic signs, work zone indicia, vehicle reflectors, personal reflective safety equipment, and the like.

Flexible, roll-up articles are advantageous for colored retroreflective sheeting applications, providing improved impact safety, ease of storage, and portability. However, colorants, i.e., dyes or pigments, can fade quickly after exposure to sunlight, particularly when incorporated in a flexible polymer. In particular, fluorescent colorants supported in a flexible polymer in combination with a retroreflective structure can quickly fade, though the retroreflective structure may continue to function.

Several examples teach the combination of fluorescent colorants, polymers, and low molecular weight hindered amine light stabilizer (HALS) compounds. While these low molecular weight (i.e., less than 1,000 atomic mass units (AMU)) compounds can provide some fade resistance, they also lead to the formation of surface haze, when the polymer includes polyvinyl chloride (PVC). This phenomenon can be particularly evident after hot processing (such as calendering). Without wishing to be bound by theory, it is believed that acids can be liberated during processing or reactions with residual emulsifying agents from the raw homopolymer resin, and these acids are believed to react with the amine functional sites to create inert insoluble particles that can appear as a haze. This obscuring haze can scatter and block incident and reflected light, reducing the visibility of the article. Furthermore, as a surface contaminant, the haze leads to poor adhesion of inks, paints, and adhesive-backed symbols, letters, or logos on the surface of the polymer. Coatings would have to be applied to the PVC surface to eliminate this problem. This results in added cost and manufacturing process steps.

Another example teaches the use of HALS compounds of molecular weight greater than 1,500 AMU. However, this example requires the use of a particular class of perylene imide dyes, and teaches that other dyes, for example thioxanthene dyes, perform poorly. This single class of perylene dyes is expensive and is not appropriate for all applications. Furthermore, this example can also require a particular class of polymer and plasticizer, which is also expensive and not appropriate for all applications.

Therefore, a need exists in the art to provide haze-free fade resistance for a variety of colorants in a variety of polymeric materials. In particular, there is a need for improved haze-free fade resistance for fluorescent colorants in a polyvinyl chloride article in combination with a retroreflective structure.

### SUMMARY OF THE INVENTION

It has now been found that high-molecular weight hindered amine light stabilizers provide haze-free fade resistance to colorants, particularly fluorescent colorants such as thioxanthenes and pyrazolones in combination with a flexible polymer, such as polyvinyl chloride, as demonstrated in Examples 1 and 2.

A fade-resistant fluorescent colorant composition includes a polymer; a fade-susceptible fluorescent colorant, provided the fluorescent colorant is not a perylene imide derivative; and a hindered amine light stabilizer of molecular weight greater than about 1,200 AMU. The hindered amine light stabilizer includes at least one secondary or tertiary hindered amine.

A fade-resistant retroreflective article includes the colorant composition and a retroreflective structure, including an array of transparent optical elements.

Another fade-resistant retroreflective article includes a colorant composition, including a polymer; a fade-susceptible fluorescent colorant; and a hindered amine light stabilizer of molecular weight greater than about 1,200 AMU. Also included is a retroreflective structure, including an array of transparent cube-corner prisms. Adjacent prisms form prism pairs in which the tips of the apices of the prism pairs are tilted with respect to one another. Optionally, a reflective coating can be deposited on the facets of the prisms.

Also included are methods for forming the composition and articles.

The advantages of the embodiments disclosed herein are significant. By providing fade resistance, the lifetime of colored articles exposed to light, particularly flexible fluorescent retroreflective articles, can be increased by a factor of two or more compared to conventional formulations. By incorporating a high molecular weight hindered amine light stabilizer, the formation of undesirable surface haze is reduced. The result is a significant improvement in safety and performance for retroreflective articles for traffic signs, work zone indicia, vehicle reflectors, personal reflective safety equipment, and the like. Also, the aesthetic appearance of the retroreflective article is maintained.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. All percentages and parts are by weight unless otherwise indicated.

FIG. 1 shows a cross-sectional view of a first retroreflective article with a fade-resistant fluorescent composition.

FIG. 2 shows a cross-sectional view of a second retroreflective article with a fade-resistant fluorescent composition.

FIG. 3 shows a cross-sectional view of a third retroreflective article with a fade-resistant fluorescent composition.

FIG. 4 depicts the substantial improvement in lifetime that can be achieved using a high molecular weight HALS.

### DETAILED DESCRIPTION OF THE INVENTION

The foregoing and other objects, features and advantages of the invention will be apparent from the following more particular description of preferred embodiments of the invention. All percentages and parts are by weight unless otherwise indicated.

A fluorescent colorant is a dye or pigment containing a fluorescent organic molecule. Detailed descriptions of fluorescent colorants can be found in Zollinger, H., “Color Chemistry: Synthesis, Properties, and Applications of Organic Dyes and Pigments”, 2^{nd} Ed., VCH, New York, 1991, the entire teachings of which are incorporated herein by reference. As used herein, a fluorescent colorant can be, for example, a compound or derivative thereof selected from xanthene, thioxanthene, fluorene derivatives (e.g., fluoresceins, rhodamines, eosines, phloxines, uranines, succineins, sacchareins, rosamines, and rhodols), napthylamine, naphthylimide, naphtholactam, azalactone, methine, oxazine, thiazine, benzopyran, coumarin, aminoketone, anthraquinone, isoviolanthrone, anthrapyridone, pyranine, pyrazolone, benzothiazene, perylene, and thioindigoid. More preferably, a fluorescent colorant is a compound or derivative thereof selected from the group consisting of xanthene, thioxanthene, benzopyran, coumarin, aminoketone, anthraquinone, isoviolanthrone, anthrapyridone, pyranine, pyrazolone, benzothiazene, thioindigoid and fluorene. Most preferably, the fluorescent colorant is a thioxanthene or thioxanthene derivative.

The term “derivative” as used herein means that chemically substituted variants of the named core structures are contemplated, for example, a thioxanthene derivative can be thioxanthene, or thioxanthene substituted with one or more functional groups, for example, halogen (e.g., —F, —Cl, —Br, and —I), —OH, —NO₂, —CN, optionally substituted alkyl, amino, alkoxy, aryl, heteroaryl, cycloalkyl, nonaromatic heterocycle, and the like. Other substituents can be fused rings, e.g., an optionally substituted, aryl, heteroaryl, cycloalkyl, or nonaromatic heterocycle that shares two ring atoms in common with the core fluorescent colorant structure

The term “aryl” group refers to carbocyclic aromatic groups such as phenyl, naphthyl, and anthracyl. The term “heteroaryl” group refers to heteroaromatic groups such as imidazolyl, isoimidazolyl, thienyl, furanyl, pyridyl, pyrimidyl, pyranyl, pyrazolyl, pyrrolyl, pyrazinyl, thiazolyl, isothiazolyl, oxazolyl, isooxazolyl, 1,2,3-triazolyl, 1,2,4-triazolyl, and tetrazolyl. As used herein, a “heteroaryl” group is a 5 membered carbocyclic ring containing at least one N, S, or O atom and two double bonds, or a 6 membered carbocyclic ring containing at least one N, S, or O atom and three double bonds.

The term “nonaromatic heterocycle” refers to non-aromatic ring systems typically having four to eight members, preferably five to six, in which one or more ring carbons, preferably one to four, are each replaced by a heteroatom such as N, O, or S. Examples of non-aromatic heterocyclic rings include 3-tetrahydrofuranyl, 2-tetrahydropyranyl, 3-tetrahydropyranyl, 4-tetrahydropyranyl, [1,3]-dioxalanyl, [1,3]-dithiolanyl, [1,3]-dioxanyl, 2-tetrahydrothiophenyl, 3-tetrahydrothiophenyl, 2-morpholinyl, 3-morpholinyl, 4-morpholinyl, 2-thiomorpholinyl, 3-thiomorpholinyl, 4-thiomorpholinyl, 1-pyrrolidinyl, 2-pyrrolidinyl, 3-pyrorolidinyl, 1-piperazinyl, 2-piperazinyl, 1-piperidinyl, 2-piperidinyl, 3-piperidinyl, 4-piperidinyl, 4-thiazolidinyl, diazolonyl, N-substituted diazolonyl, and 1-pthalimidinyl.

The term “alkyl”, used alone or as part of a larger moiety (e.g., aralkyl, alkoxy, alkylamino, alkylaminocarbonyl, haloalkyl), is a straight or branched non-aromatic hydrocarbon which is completely saturated. Typically, a straight or branched alkyl group has from 1 to about 10 carbon atoms, preferably from 1 to about 5 if not otherwise specified, Examples of suitable straight or branched alkyl group include methyl, ethyl, n-propyl, 2-propyl, n-butyl, sec-butyl, tert-butyl, pentyl, hexyl, heptyl or octyl. A C1-C10 straight or branched alkyl group or a C3-C8 cyclic alkyl group can also be referred to as a “lower alkyl” group. An “alkoxy” group refers to an alkyl group that is connected through an intervening oxygen atom, e.g., methoxy, ethoxy, 2-propyloxy, tert-butoxy, 2-butyloxy, 3-pentyloxy, and the like.

The term “cycloalkyl” is a cyclic alkyl group has from 3 to about 10 carbon atoms, preferably from 3 to about 7. Examples of suitable cycloalkyl groups include cyclopropyl, cyclobutyl, cyclopentyl, cyclohexyl, cycloheptyl and cyclooctyl. A “cycloalkoxy” group refers to a cycloalkyl group that is connected through an intervening oxygen atom, e.g., cyclopentyloxy, cyclohexyloxy, and the like.

One skilled in the art knows that for many commercially available colorants, the specific chemical structure of individual derivatives within a class, e.g., thioxanthene derivatives, may not be publicly available. Thus, specific fluorescent colorants are typically referred to by Colour Index (C.I.) name, as defined in “Colour Index International”, 4^{th} Ed. American Association of Textile Chemists and Colorists, Research Triangle Park, N.C., 2002. The Colour Index is also available online at http://www.colour-index.org/. The entire teachings of the Colour Index are incorporated herein by reference.

Examples of preferred fluorescent colorants include C.I. Solvent Orange 63 (Hostasol Red GG, Hoechst AG, Frankfurt, Germany), C.I. Solvent Yellow 98 (Hostasol Yellow 3G, Hoechst AG, Frankfurt, Germany), and C.I. Solvent Orange 118 (FL Orange SFR, Keystone Aniline Corporation, Chicago, Ill.).

The amount of colorant that can be employed depends on the particulars of the intended use, the characteristics of the colorant, the other components in the composition, and the like. One skilled in the art will know how to judge these details to determine the amount of colorant for a particular use. Typically, the amount of colorant will be a weight fraction of the total colorant composition of between about 0.01 and about 2%, more preferably between about 0.05 and about 0.5%, and most preferably, about 0.2%.

An ultraviolet absorber is a compound that absorbs a fraction of incident light having a wavelength shorter than about 425 nanometers, or more preferably, shorter than about 400 nanometers. Suitable ultraviolet absorbers include benzophenone, benzotriazole, triazine, their derivatives, and the like. One skilled in the art will know of many other commercially available ultraviolet absorbers that can be suitable.

The amount of ultraviolet absorber that can be employed depends on the particulars of the intended use, the thickness of the colorant composition, the other components in the composition, and the like. One skilled in the art will know how to judge these details to determine the amount of ultraviolet absorber for a particular use. Typically, the amount of ultraviolet absorber will be a weight fraction of the total colorant composition of between about 0.01 and about 3%, more preferably between about 0.05 and about 1%, and most preferably, about 0.5%.

A HALS is a compound, typically an oligomer or a polymer, containing one or preferably at least two, secondary or tertiary amines that are sterically hindered. Typically, a HALS can contain between about 8 to about 14 hindered amine groups. “Sterically hindered” means that groups adjacent to or attached to the amine are sterically bulky, for example, branched alkyl groups such as tertiary butyl groups or rings such as phenyl, cyclopentyl, cyclohexyl, and the like. Examples of tertiary hindered amine groups include, for example, diphenylamino, di-tertbutylamino, 2,2′6,6′-tetramethyl N-methyl piperidyl, 2,2′,5,5′-tetramethyl N-methyl pyrrolidyl, and the like. Examples of hindered secondary amine groups include 2,2′6,6′-tetramethyl piperidyl, 2,2′,5,5′-tetramethyl pyrrolidyl, and the like. For example, two suitable HALSs are represented by structural formulas I and II.

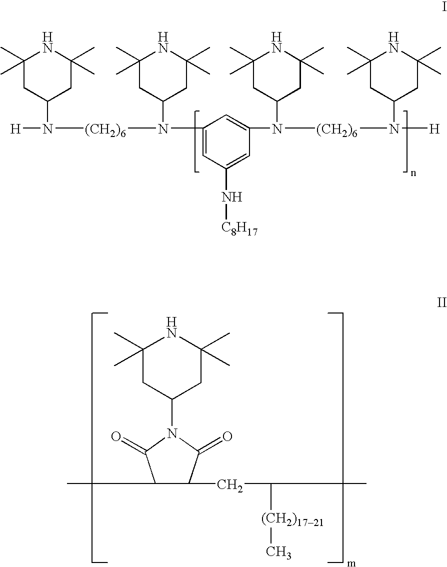

In the preceding, n can be from 1 to about 10, more typically from 2 to about 8, and preferably from about 3 to about 6; m can be from about 4 to about 18, more typically from about 6 to about 16, and preferably from about 8 to about 14.

The hindered amine functionality can also include N-alkoxy hindered amine derivatives. The N-alkoxy hindered amine derivatives can be less basic than other hindered amines, and are believed to be more tolerant of acidic environments, for example, as believed to exist in the calendering of polyvinyl chloride films. These N-alkoxy hindered amine derivatives can be polymeric or high molecular weight monomeric. Several N-alkoxy hindered amine products are commercially available. For example, one commercially available N-alkoxy hindered amine composition is a proprietary mixture believed to contain compound III as a major component and compound IV as a minor component:

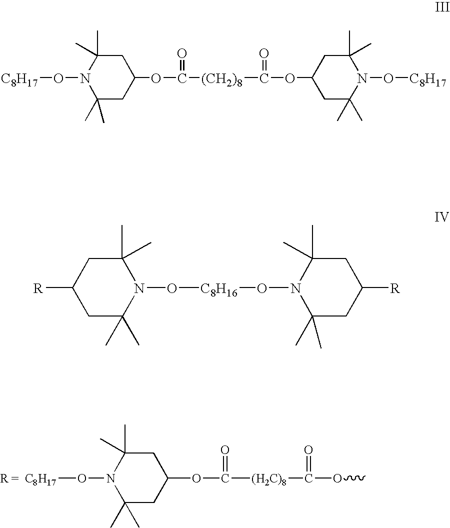

Another commercially available N-alkoxy hindered amine composition is described as a hindered N-alkoxy hindered amine derivative of molecular weight between about 2,800 and about 4,000 AMU. Another example is a proprietary product believed to be the reaction product of N,N′-ethane-1,2-diylbis (1,3-propanediamine), cyclohexane, peroxidized 4-butylamino-2,2,6,6-tetramethylpiperidine, and 2,4,6-trichloro-1,3,5-triazine.

The molecular weight of the HALS is greater than about 1,200 AMU. Preferably, the molecular weight of the HALS can be between about 1,500 AMU and 10,000 AMU, more preferably between about 2,000 AMU and about 7,500 AMU, or even more preferably, between about 2,500 AMU and 5,000 AMU.

The HALS is preferably soluble in the polymer. “Soluble” means that the HALS, when incorporated into the polymer, is substantially in the form of individual HALS molecules dispersed throughout the polymer.

The amount of HALS that can be employed depends on the particulars of the intended use, the amount of colorant in the composition, the other components in the composition, and the like. One skilled in the art will know how to judge these details to determine the amount of HALS for a particular use. Typically, the amount of HALS is a weight fraction of the total composition of between about 0.01 and about 5%, more preferably between about 0.1 and about 2%, and most preferably, about 0.5 to 1%.

The polymer includes, for example, optionally substituted polyvinyl chloride, polyvinyl acetate, polyvinylidine chloride, polystyrene, polyurethane, polyurethane acrylate, polysiloxane, polyisoprene, polyisobutylene, polybutadiene, polypropylene, polyethylene, and polyacrylate. Preferably, the polymer includes polyvinyl chloride.

The amount of polymer that can be employed depends on the particulars of the intended use, the thickness of the article, the other components in the composition, and the like. One skilled in the art will know how to judge these details to determine the amount of polymer for a particular use. Typically, the amount of polymer is a weight fraction of the total composition of between about 50 and about 98%.

The polymer can include a plasticizer, for example, optionally substituted phthalate esters, adipate esters, and sebacate esters. Suitable plasticizers can include, for example, monomeric plasticizers such as di-iso-nonyl phthalate, di (2-ethylhexyl) phthalate, dibutyl phthalate, di-iso-decyl phthalate, di-n-octyl phthalate, butylbenzyl phthalate, di (propylheptyl) phthalate, diundecyl phthalate, dinonyl phthalate, diheptyl phthalate, di (2-ethylhexyl) adipate, dioctyl adipate, dioctyl sebacate, di (2-ethylhexyl) sebacate, and polymeric plasticizers derived from adipic acid and polyhydric alcohols. Preferably, the plasticizer includes monomeric phthalate esters of linear seven to twelve carbon alcohols or blends thereof, e.g., di-n-heptyl phthalate, di-n-octyl phthalate, di-n-nonyl phthalate, di-n-decyl phthalate, di-n-undecyl phthalate, and di-n-dodecyl phthalate.

The amount of plasticizer that can be employed depends on the particulars of the intended use, the thickness of the article, the other components in the composition, and the like. One skilled in the art will know how to judge these details to determine the amount of plasticizer for a particular use. Typically, the amount of plasticizer is a weight fraction of the total composition of between about 5 and about 65%, more preferably between about 15 and about 40%, and most preferably, about 25%.

The components of the colorant composition can be incorporated into the polymer by processing in a heated mechanical mixer or mill. The resulting mixture can be poured or extruded to form a layer or other article of the colorant composition. Optionally, the polymer can include monomers or partially cured components that polymerize during the formulation process.

A preferred fade-resistant fluorescent colorant composition includes polyvinyl chloride; a phthalate ester plasticizer; an ultraviolet absorber; a fade-susceptible fluorescent colorant that is a benzopyran, coumarin, xanthene, thioxanthene, or thioindigiod derivative; and a hindered amine light stabilizer of molecular weight greater than about 2,500 AMU, wherein the hindered amine light stabilizer includes at least two secondary or tertiary hindered amines. Preferably, the fluorescent colorant is a thioxanthene, or most preferably, C.I. Solvent Orange 63, C.I. Solvent Yellow 98 or C.I. Solvent Orange 118.

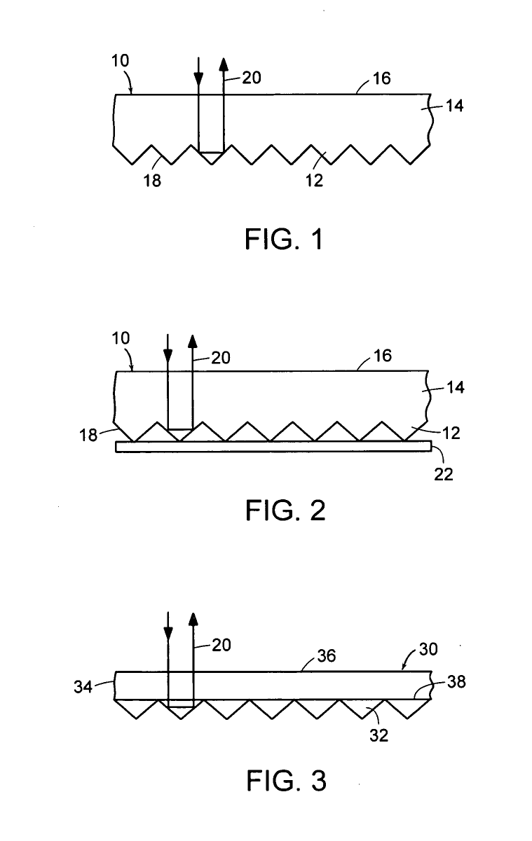

FIG. 1 shows a retroreflective article 10. Retroreflective structure 10 includes an array of cube-corner elements 12 and a land layer 14. Light can enter the retroreflective structure 10 through window surface 16. The light can pass through land layer 14 and strike facets 18 of cube-corner elements 12 and return in the direction from which it came as shown by arrow 20. Retroreflective structure 10 can include a fade-resistant fluorescent colorant composition that includes a flexible polymeric matrix, a fade-susceptible fluorescent colorant, and a hindered amine light stabilizer.

FIG. 2 shows a retroreflective structure 10, as shown in FIG. 1, with a backing layer 22 to form an air-backed product. Backing layer 22 can include a fade-resistant fluorescent colorant composition that includes a flexible polymeric matrix, a fade-susceptible fluorescent colorant, and a hindered amine light stabilizer. The fade-resistant fluorescent colorant composition can be in the backing layer or in land layer 14 or in array of cube-corner elements 12 or a combination thereof.

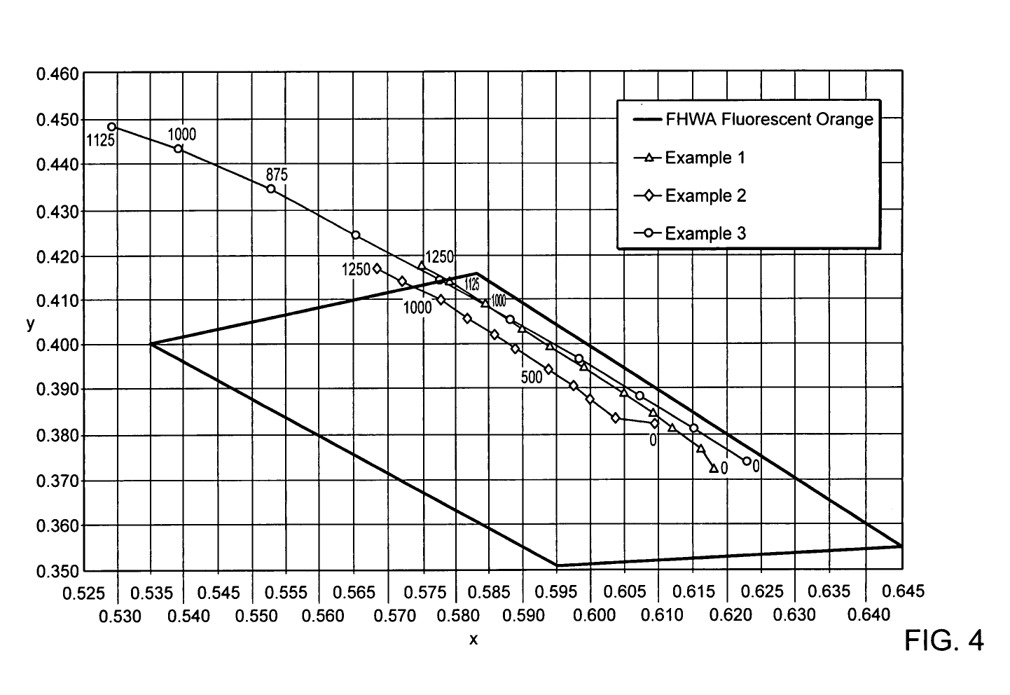

FIG. 3 shows another retroreflective structure 30 that includes an array of cube-corner elements 32 and a body layer 34 having a window side 36 and a prism side 38. The cube-corner elements 32 are formed on the body layer 34 and project from prism side 38 of the body layer. The fade-resistant fluorescent colorant composition can be incorporated in the body layer 34 or in the array of cube-corner elements 32 or a combination thereof.

A preferred fade-resistant retroreflective article includes a colorant composition and a retroreflective structure including an array of transparent optical elements. The colorant composition includes a polymer, including polyvinyl chloride and a plasticizer; a fade-susceptible fluorescent colorant that includes a benzopyran, coumarin, xanthene, thioxanthene, or thioindigiod derivative; an ultraviolet absorber; and a hindered amine light stabilizer of molecular weight greater than about 2,500 AMU, wherein the hindered amine light stabilizer includes at least two secondary or tertiary hindered amines. Preferably, the fluorescent colorant is C.I. Solvent Orange 63, C.I. Solvent Yellow 98 or C.I. Solvent Orange 118.

Another preferred fade-resistant retroreflective article includes a colorant composition and a retroreflective structure. The colorant composition includes a polymer; a fade-susceptible fluorescent colorant; and a hindered amine light stabilizer of molecular weight greater than about 1,200 AMU. The retroreflective structure includes an array of transparent cube-corner prisms, wherein adjacent prisms form prism pairs in which the tips of the apices of the prism pairs are tilted (canted) with respect to one another; and a reflective coating is optionally adhered to the facets of the prisms.

In another embodiment, the colorant composition can be a thin layer that is attached to the window surface of the retroreflective structure.

The array of retroreflectors can include any transparent optical elements that are known in the art, e.g., cube-corner prisms, four-sided prisms, Fresnel lenses, rounded lenses, and the like. In one embodiment, the array of retroreflectors has a window side and a facet side. The array of retroreflectors can be formed of a transparent polymer, e.g., polyvinyl chloride. Preferably, the polymer is cast in a mold with a monomer or oligomer, and the polymerization is initiated by ultraviolet radiation. Preferably, the array of retroreflectors is formed of cube-corner prism elements having a length along each cube side edge in the range of between about 0.076 and 0.51 mm (0.003 and 0.02 inches). In a preferred embodiment, the prism elements have a length along each cube-side edge in the range of between 0.124 and 0.51 mm (0.0049 and 0.02 inches). In a particularly preferred embodiment, each cube-side edge has a length of about 0.124 mm (0.0049 inches).

The retroreflective structure can be formed by numerous methods. Some of the methods for forming a retroreflective structure are disclosed in U.S. Pat. No. 3,684,348, issued to Rowland on Aug. 15, 1972; U.S. Pat. No. 3,689,346, issued to Rowland on Sep. 5, 1972; U.S. Pat. No. 3,811,983, issued to Rowland on May 21, 1974; U.S. Pat. No. 3,830,682, issued to Rowland on Aug. 20, 1974; U.S. Pat. No. 3,975,083, issued to Rowland on Aug. 17, 1976; U.S. Pat. No. 4,332,847, issued to Rowland on Jun. 1, 1982; U.S. Pat. No. 4,801,193, issued to Martin on Jan. 31, 1989; U.S. Pat. No. 5,229,882, issued to Rowland on Jul. 20, 1993; U.S. Pat. No. 5,236,751, issued to Martin et al. on Aug. 17, 1993; U.S. Pat. No. 5,264,063, issued to Martin on Nov. 23, 1992; U.S. Pat. No. 5,376,431, issued to Rowland on Dec. 27, 1994; U.S. Pat. No. 5,491,586, issued to Phillips on Feb. 13, 1996; U.S. Pat. No. 5,512,219, issued to Rowland on Apr. 30, 1996; U.S. Pat. No. 5,558,740, issued to Bernard et al. on Sep. 24, 1996; U.S. Pat. No. 5,592,330, issued to Bernard on Jan. 7, 1997; U.S. Pat. No. 5,637,173, issued to Martin et al. on Jun. 10, 1997; U.S. Pat. No. 3,712,706, issued to Stamm on Jan. 23, 1973; U.S. Pat. No. 3,684,348, issued to Rowland, Aug. 15, 1972; U.S. Pat. No. 5,786,066, issued to Rowland, Jul. 28, 1998; U.S. Pat. No. 6,143,224, issued to Bernard et al. Nov. 7, 2000; and U.S. Pat. No. 5,565,151, issued to Nilsen on Oct. 15, 1996. The entire teachings of each of the preceding patents are incorporated herein by reference.

The efficiency of a retroreflective structure can be described as the measure of the amount of incident light returned within a cone diverging from the axis of retroreflection. A distortion of the prismatic structure can adversely affect the efficiency. Furthermore, cube-corner retroreflective elements can have low angularity at some orientation angles, for instance, the elements typically only brightly reflect light that impinges on it within a narrow angular range centering approximately on its optical axis. Low angularity arises from the inherent nature of these elements which are trihedral structures having three mutually perpendicular lateral faces. The elements can be arranged so that the light to be retroreflected impinges into the internal space defined by the faces, and the retroreflection of the impinging light occurs by internal retroreflection of the light from face to face of the element. Impinging light that is inclined substantially away from the optical axis of the element (which is a trisection of the internal space defined by the faces of the element) strikes the face at an angle less than its critical angle, thereby passing through the face rather than being reflected.

Cube-corner or prismatic retroreflectors are described in Stamm, U.S. Pat. No. 3,712,706, and Rowland, U.S. Pat. No. 3,684,348. Such prisms can typically be made by forming a master die on a flat surface of a metal plate or other suitable material. To form the cube-corner, three series of parallel equidistant intersecting V-shaped grooves 60 degrees apart can be inscribed in the plate. The die can then be employed to process the desired cube-corner array into a flat plastic surface. When the groove angle is 70 degrees, 31 minutes, 43.6 seconds, the angle formed by the intersection of two cube faces (dihedral angle) is 90 degrees and the incident light can be retroreflected back to the source. In the resultant structure, adjacent prisms can form prism pairs in which the tips of the apices of the prism pairs are tilted with respect to one another. The prisms are bonded to sheeting which is applied thereover to provide a composite structure in which cube-corner microprisms project from one surface of the sheeting, as in retroreflective structure 10.

An adhesive can be applied to the prism facets for attaching a backing layer to the retroreflective structure. If an adhesive is employed on the prism facets, the adhesive can cause the surface of the prisms to wet, thereby reducing the air interface and affecting the ability of the prism to retroreflect. As a result, an optional reflective coating is preferably deposited on the surface of the dihedral facets. Typically, the reflective coating is formed by sputtering or vacuum metalization of a metal, e.g., aluminum, silver, gold, and the like. Alternatively, metal lacquers, dielectric coatings and other specular coating materials known to one skilled in the art can be employed.

The prism layer can also be compression molded or cast directly onto the fluorescent colored layer or attached by means of a tiecoat. The prism layer can be formed of polyvinyl chloride, an acrylate or other suitable polymer.

This prismatic sheeting configuration can also be sealed to any number of backing materials by radio frequency, thermal, or sonic welding methods. The daytime color saturation (chroma) properties of a transparent fluorescent material are increased if backed by a white layer. It is desirable to have the backing be white in color on the surface behind the prisms. Alternatively, the prismatic material can be metalized in an aesthetically appealing pattern and laminated to a white pressure sensitive substrate adhesive. Similarly, a pattern can be printed onto the film prior to casting, or onto the backs of the prisms after casting, using a white ink to enhance the daytime chroma. However, these methods enhance the daytime fluorescent color at the expense of some of the retroreflective area, because the non-metalized prisms that have their facets covered with adhesive do not maintain a differentiation in refractive index that is sufficiently large for internal reflection to occur.

Both of the latter construction alternatives have the advantage of not having an air gap in the construction behind the prism layer. Elimination of the air gap can help augment the physical durability of the sheeting, because each layer of the product has about 100% of its surface bonded to its adjacent layers.

The retroreflective article can conform to “Specification 1710 for Fluorescent Orange Retroreflective Sheeting for Use on Work Zone Traffic Control Devices”, available from the Minnesota Department of Transportation, St. Paul, Minn., the entire teachings of which are incorporated herein by reference. Specification 1710 defines a color box (see Product Testing Requirements and Specification section), reflectance limits (30 minimum new, 20 minimum to 45 maximum for weathered (500 Weatherometer hours)), and a table (B) of Minimum Coefficients of Retroreflection approximate the 1,300 hour color retention in a xenon lamp accelerated weathering device.

### EXAMPLES

The following Examples are presented in order to illustrate the invention, and are not intended to be limiting in any way.

A base polyvinyl chloride plastisol was made by addition of 63 parts of a plasticizer mixture to 100 parts of dry homopolymer polyvinyl chloride resin. The plasticizer mixture was a blend of diheptyl phthalate, dinonyl phthalate, and diundecyl phthalate such that the resulting specific gravity was about 0.971 and the dynamic viscosity was about 50 mPa.s (milliPascal-seconds) at 20° C.

To this 2-hydroxy-4-n-octoxybenzophenone was added as a UV absorber at 0.6% by total formula weight. This plastisol was then colored with C.I. Solvent Orange 63 and C.I. Solvent Orange 118 at a loading of 0.165% weight percent each versus total weight of homopolymer polyvinyl chloride resin. This mixture, designated as Base Resin A, was employed in the examples, e.g., the specific hindered amine of interest was added to Base Resin A as follows.

Examples 1 and 2 demonstrate the present invention, while Example 3 represents the “prior art”, i.e., with HALS having a molecular weight less than 1,000.

| Example | Hindered Amine | Molecular Weight | % by Weight |
|---|---|---|---|
| 1 | U5050H | ˜3500 | 1.00 |
| 2 | BLS-1944 | 2000-3300 | 1.00 |
| 3 | T765 | 509 | 0.50 |

In the above examples, U5050H is Uvinul 5050H and was obtained from BASF, Mount Olive, N.J.; Chicago, Ill.; BLS-1944 was obtained from Mayzo, Norcorss, Ga.; and T765 is Tinuvin 765 was obtained from Ciba, Tarrytown, N.Y.

These formulations were plastisols which were subsequently cured into transparent films (300 μm (micrometer) thick nominal) on a polished surface by exposure to 195° C. for 5 minutes. The films were then made into microprismatic retroreflective sheeting by casting an ultra violet-curable urethane acrylate oligomer on a cube corner tool, similar to the method described in Rowland, U.S. Pat. No. 5,786,066.

This material was then made into tape by radio frequency sealing to an opaque white polyvinyl chloride backing by the method to described in Bernard et. al, U.S. Pat. No. 6,143,224.

The tapes were then prepared into weatherometer samples by mounting them onto 0.5 mm (millimeter) thick by 75 mm by 150 mm aluminum panels.

The samples were then read for color under D65 illuminant at 2° observation angle on a HunterLab LabScan II Spectrophotometer and fluorescence on a Labsphere BFC-450 Bispectral Fluorescence Colorimeter. The samples were tested in an Atlas C35i xenon weatherometer using “ASTM G26 Accelerated Weathering Test Method”, available from the American Society for Testing and Materials, West Conshohocken, Pa., the entire teachings of which are incorporated herein by reference. The samples were re-read for color and fluorescence after every 125 hours of exposure time.

In Example 3 only 0.5% by weight loading of HALS was possible without generating an objectionable amount of surface bloom/haze thereby obscuring retroreflection.

FIG. 4 depicts the substantial improvement in lifetime that can be achieved using a high molecular weight HALS. The CIE 1931 color space for a xenon weatherometer aging comparison of fluorescent orange retroreflective prismatic polyvinyl chloride films is depicted. The four-sided figure is the color box for FHWA fluorescent orange. Examples 1 (triangle symbol) and 2 (diamond symbol) both maintained their orange color for about 1,125 hours. In comparison, Example 3 (circle symbol) maintained its orange color for only about 625 hours, a substantially lesser amount of time.

### EQUIVALENTS

While this invention has been particularly shown and described with references to preferred embodiments thereof, it will be understood by those skilled in the art that various changes in form and details may be made therein without departing from the scope of the invention encompassed by the appended claims.

1. A fade-resistant fluorescent colorant composition, comprising:
a polymer;
a fade-susceptible fluorescent colorant, provided the fluorescent colorant is not a perylene imide derivative; and
a hindered amine light stabilizer of molecular weight greater than about 1,200 AMU, wherein the hindered amine light stabilizer includes at least one secondary or tertiary hindered amine.

2. The composition of claim 1, wherein the fluorescent colorant is a xanthene, thioxanthene, fluorene, napthylamine, naphthylimide, naphtholactam, azalactone, methine, oxazine, thiazine, benzopyran, coumarin, aminoketone, anthraquinone, isoviolanthrone, anthrapyridone, pyranine, pyrazolone, benzothiazene, or thioindigoid derivative.

3. The composition of claim 1, further comprising an ultraviolet absorber.

4. The composition of claim 1, wherein the hindered amine light stabilizer includes at least two secondary or tertiary hindered amines.

5. The composition of claim 1, wherein the hindered amine light stabilizer is soluble in the polymer.

6. The composition of claim 1, wherein the polymer comprises a polymer selected from the group consisting of optionally substituted polyvinyl chloride, polyvinyl acetate, polyvinylidine chloride, polystyrene, polyurethane, polyurethane acrylate, polysiloxane, polyisoprene, polyisobutylene, polybutadiene, polypropylene, polyethylene, and polyacrylate.

7. The composition of claim 1, wherein the polymer includes a plasticizer selected from the group consisting of optionally substituted phthalate esters, adipate esters, and sebacate esters.

8. The composition of claim 1, wherein the fluorescent colorant includes a benzopyran, coumarin, xanthene, thioxanthene, or thioindigiod derivative.

9. The composition of claim 1, wherein the hindered amine light stabilizer has a molecular weight greater than about 2,500 AMU.

10. The composition of claim 9, wherein the polymer includes polyvinyl chloride.

11. The composition of claim 1, wherein hindered amine light stabilizer includes at least one member selected from the group consisting of:
a compound represented by structural formula I; 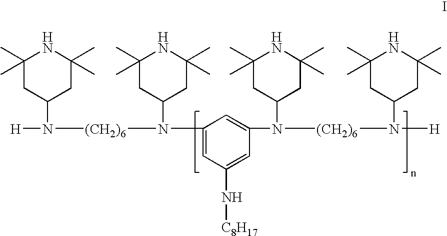
a compound represented by structural formula II: 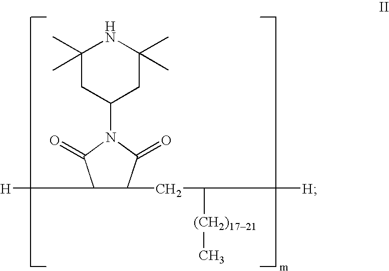
a mixture containing compounds represented by structural formulas III and IV: 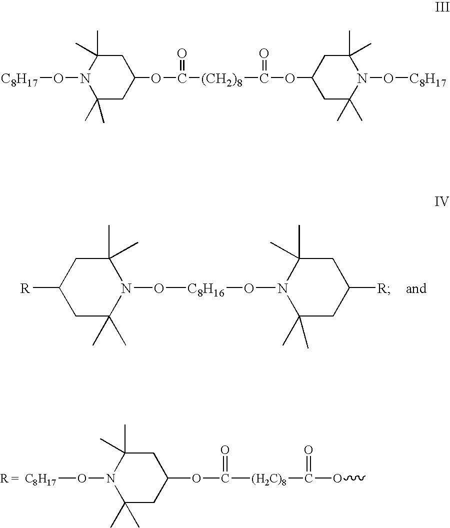
the reaction product of N,N′-ethane-1,2-diylbis (1,3-propanediamine), cyclohexane, peroxidized 4-butylamino-2,2,6,6-tetramethylpiperidine, and 2,4,6-trichloro-1,3,5-triazine;
wherein n is from 3 to 6 and m is from 8 to 14.

12. The composition of claim 11, wherein the fluorescent colorant is selected from the group consisting of Solvent Orange 63, Solvent Yellow 98, and Solvent Orange 118.

13. A fade-resistant retroreflective article, comprising:
a colorant composition, comprising:
a polymer;
a fade-susceptible fluorescent colorant, provided that the fluorescent colorant is not a perylene imide derivative;
a hindered amine light stabilizer of molecular weight greater than about 1,200 AMU, wherein the hindered amine light stabilizer includes at least one secondary or tertiary hindered amine; and
a retroreflective structure, comprising an array of transparent optical elements.

14. The article of claim 13, wherein the fluorescent colorant includes a xanthene, thioxanthene, fluorene, napthylamine, naphthylimide, naphtholactam, azalactone, methine, oxazine, thiazine, benzopyran, coumarin, aminoketone, anthraquinone, isoviolanthrone, anthrapyridone, pyranine, pyrazolone, benzothiazene, or thioindigoid derivative.

15. The article of claim 14, wherein the elements include cube-corner prisms.

16. The article of claim 15, wherein adjacent prisms form prism pairs in which the tips of the apices of the prism pairs are tilted with respect to one another.

17. The article of claim 13, wherein the hindered amine light stabilizer includes at least two secondary or tertiary hindered amines.

18. The article of claim 13, wherein the polymer includes polyvinyl chloride and a plasticizer.

19. The article of claim 13, wherein the hindered amine light stabilizer has a molecular weight greater than about 2,500 AMU.

20. The article of claim 13, wherein the fluorescent colorant includes a xanthene, thioxanthene, or fluorene derivative.

21. The article of claim 13, wherein the fluorescent colorant is selected from the group consisting of Solvent Orange 63, Solvent Yellow 98, and Solvent Orange 118.

22. A method of forming a fade-resistant colorant composition, comprising:
incorporating, into a polymer:
a fade-susceptible fluorescent colorant, provided the fluorescent colorant is not a perylene imide derivative; and
a hindered amine light stabilizer of molecular weight greater than about 1,200 AMU, wherein the hindered amine light stabilizer includes at least one secondary or tertiary hindered amine.

23. The method of claim 22, wherein the fluorescent colorant is a xanthene, thioxanthene, fluorene, napthylamine, naphthylimide, naphtholactam, azalactone, methine, oxazine, thiazine, benzopyran, coumarin, aminoketone, anthraquinone, isoviolanthrone, anthrapyridone, pyranine, pyrazolone, benzothiazene, or thioindigoid derivative.

24. The method of claim 22, wherein the hindered amine light stabilizer includes at least two secondary or tertiary hindered amines.

25. The method of claim 24, further comprising dissolving the hindered amine light stabilizer in the polymer.

26. The method of claim 25, wherein the hindered amine light stabilizer has a molecular weight greater than about 2,500 AMU.

27. The method of claim 22, wherein the polymer comprises a plasticizer selected from the group consisting of optionally substituted phthalate esters, adipate esters, and sebacate esters.

28. The method of claim 22, wherein the hindered amine light stabilizer includes at least one member selected from the group consisting of:
a compound represented by structural formula I; 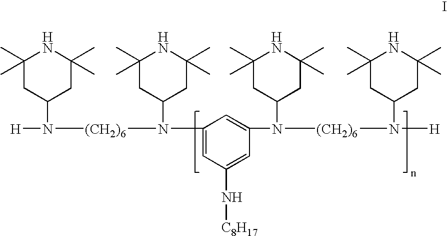
a compound represented by structural formula II: 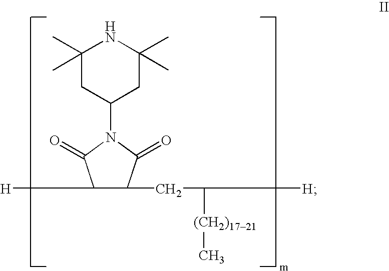
a mixture containing compounds represented by structural formulas III and IV: 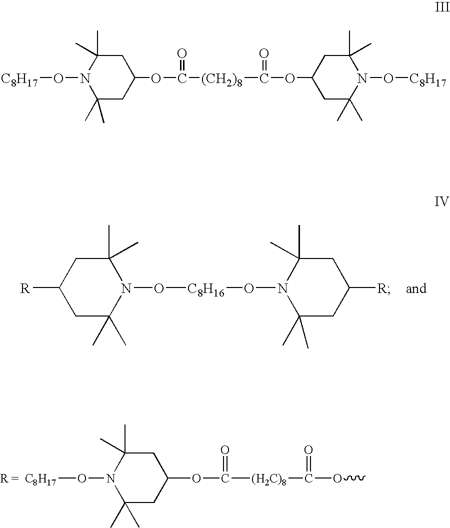
the reaction product of N,N′-ethane-1,2-diylbis (1,3-propanediamine), cyclohexane, peroxidized 4-butylamino-2,2,6,6-tetramethylpiperidine, and 2,4,6-trichloro-1,3,5-triazine;
wherein n is from 3 to 6 and m is from 8 to 14.

29. The method of claim 22, wherein the polymer includes polyvinyl chloride.

30. The method of claim 22, wherein the fluorescent colorant is selected from the group consisting of Solvent Orange 63, Solvent Yellow 98, and Solvent Orange 118.

31. A method for forming a fade-resistant retroreflective article, comprising:
forming a fade-resistant colorant composition by:
incorporating, into a polymer:
a fade-susceptible fluorescent colorant;
a hindered amine light stabilizer of molecular weight greater than about 1,200 AMU, wherein the hindered amine light stabilizer includes at least one secondary or tertiary hindered amine; and
forming a fade resistant retroreflective article by combining the fade-resistant colorant composition with an array of retroreflective elements.

32. The method of claim 31, wherein the fade-susceptible fluorescent colorant includes a xanthene, thioxanthene, fluorene, napthylamine, naphthylimide, naphtholactam, azalactone, methine, oxazine, thiazine, benzopyran, coumarin, aminoketone, anthraquinone, isoviolanthrone, anthrapyridone, pyranine, pyrazolone, benzothiazene, or thioindigoid derivative.

33. The method of claim 31, wherein the elements include cube-corner prisms.

34. The method of claim 33, wherein adjacent prisms form prism pairs in which the tips of the apices of the prism pairs are tilted with respect to one another.

35. The method of claim 31, wherein the hindered amine light stabilizer includes at least two secondary or tertiary hindered amines.

36. The method of claim 31, wherein the polymer comprises polyvinyl chloride and a plasticizer.

37. The method of claim 31, wherein the hindered amine light stabilizer includes at least one member selected from the group consisting of:
a compound represented by structural formula I; 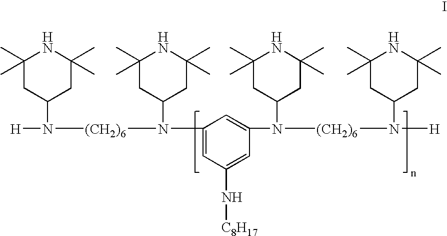
a compound represented by structural formula II: 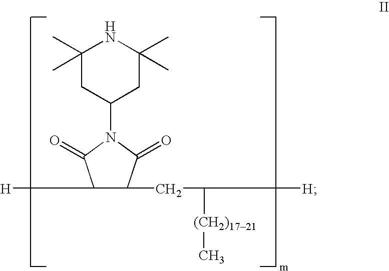
a mixture containing compounds represented by structural formulas III and IV: 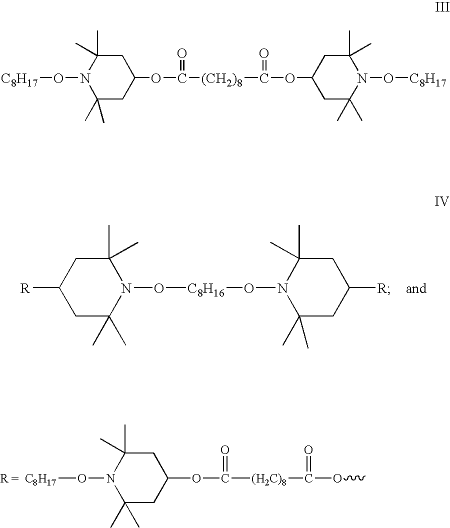
the reaction product of N,N′-ethane-1,2-diylbis (1,3-propanediamine), cyclohexane, peroxidized 4-butylamino-2,2,6,6-tetramethylpiperidine, and 2,4,6-trichloro-1,3,5-triazine;
wherein n is from 3 to 6 and m is from 8 to 14.
